(19) United States
(12) Patent Application Publication
(10) Pub. No.: US 2026/0045172 A1
(43) Pub. Date: Feb. 12, 2026

(54) Method And Apparatus For Serious Game Execution And Evaluation

(71) Applicant: Worcester Polytechnic Institute, Worcester, MA (US)

(72) Inventors: Anne M. Johnson, Portsmouth, RI (US); Michael J. Radzicki, Sterling, MA (US)

(73) Assignee: Worcester Polytechnic Institute, Worcester, MA (US)

(21) Appl. No.: 19/295,273

(22) Filed: Aug. 8, 2025

Related U.S. Application Data
(60) Provisional application No. 63/681,674, filed on Aug. 9, 2024.

(51) Int. Cl. G09B 9/00; A63F 13/798; A63F 13/822; G09B 5/02; G09B 7/02

(52) U.S. Cl. CPC G09B 9/003; A63F 13/798; A63F 13/822; G09B 5/02; G09B 7/02

(57) ABSTRACT

Embodiments of the innovation relate to a serious game and evaluation apparatus configured to execute a rubric management model for evaluation of changes to critical thinking of game participants of a serious game to inform and measure learning objectives. When executing the rubric management model, the serious game and evaluation apparatus can measure changes to dimensions of systems thinking of game participants while exploring a complex system and messy problem of interest. As such, the serious game and evaluation apparatus provides a measurement tool to inform and evaluate learning objectives for serious gaming. In one arrangement, the serious game and evaluation apparatus is configured to generate, as the serious game, a dynamic simulation model which integrates both system dynamics modeling and wargaming to provide simulation of a complex system and messy problems.

### RELATED APPLICATIONS

This patent application claims the benefit of U.S. Provisional Application No. 63/681,674 filed on Aug. 9, 2024, entitled, “Simulation/Game Intervention System with a Measurement Tool for Evaluation of Change to Systems Thinking of Simulation/Game Participants,” the contents and teachings of which are hereby incorporated by reference in their entirety.

### BACKGROUND

Complex systems can be described as a collection of tangible and intangible phenomena and their relationships which together create a whole that is greater than the sum of its parts. Messy problems can be regarded as undesired output behaviors of these complex systems and require multiple perspectives to understand and manage. For example, messy problems are confounded by the difficulty in understanding all the perspectives and dynamic relationships involved in creating the complex system itself. Systems that create messy problems can behave in counterintuitive ways and attempts to solve them can create unintended consequences that are not directly linked in space and time.

Serious games are a type of game which contribute to the understanding of complex systems and messy problems and where the primary objective of the game is user or participant learning. For example, serious games such as conventional wargames have been used over the past fifty to eighty years to explore decision making in complex situations of national security. Wargames have been used to explore emerging and ill-defined areas of national security. Conventional wargame design utilizes qualitative models based on subjective opinions to determine key variables and relationships for inclusion inside the game.

### SUMMARY

Conventional wargaming process methods suffer from a variety of deficiencies. For example, as provided above, wargaming has arguably contributed to the understanding of messy problems. However, even though wargames have been used for centuries to develop both strategists and strategies, the wargaming community acknowledges there are gaps to be filled. These gaps include criteria to evaluate if a wargame design is flawed, linking wargame output to policy decisions, and objectively measuring learning outcomes. This leaves wargame design open to criticism to how well all relevant relationships, behaviors, and consequences are considered and accounted for when modeling and simulating the interrelated social, technical, political, and environmental systems creating the messy problems.

Also as provided above, conventional wargame design methods use subjective opinions based on qualitative models to determine key variables and relationships for inclusion inside a game. However, even while using input from subject matter experts across many topics, without objective, quantitative criteria there is no means to evaluate if the chosen variables and relationships sufficiently represent the problem the wargame is meant to explore nor is there a mechanism available for comparing different games meant to explore the same problem.

Accordingly, conventional wargames which are used to develop strategies and strategists for national security and other industries are typically not evaluated for design flaws, are not repeatable, do not connect policy decisions made during game play to change in problem behavior, and do not have measurable objective learning objectives for game participants.

Further, without an understanding for how a messy problem is created, challenges to implementing a proposed solution or strategy to manage the messy problem can be mistakenly identified as the problem. The desire to focus on details of potential solutions to messy problems is understandable; technical, managerial, and operational specifications are measurable and explicable. However, without an understanding for how modifications to local behaviors will impact global behaviors in the complex system over time and space, counter-intuitive behaviors or unintended consequences can emerge from implementing a proposed solution.

By contrast to conventional wargame design methods, embodiments of the present innovation relate to a method and apparatus for serious game execution and evaluation. In one arrangement, a serious game and evaluation apparatus is configured to execute a rubric management model for evaluation of perceived problems and changes to systems thinking of game participants of a serious game to inform learning objectives. Rubrics are evaluation tools that can be used to inform, measure, and evaluate learning objectives. Systems thinking, arguably an aspect of critical thinking, offers a foundation to understand a complex system as a whole entity, as opposed to understanding the smaller, individual parts that make up the whole.

For example, when executing the rubric management model, the serious game and evaluation apparatus can measure changes to dimensions of systems thinking of game participants while exploring a complex system and messy problem of interest. As such, the serious game and evaluation apparatus provides a measurement tool to inform and evaluate learning objectives for serious gaming, such as learning for leaders or strategists in any industry or research field as well as military and national security needs.

In one arrangement, the serious game and evaluation apparatus is configured to generate, as the serious game, a dynamic simulation model which integrates both system dynamics modeling and wargaming to provide simulation of a complex system (e.g., where the complex system can include organized combinations of integrated social-technical-economic-biological phenomena) and messy problems. As such, the dynamic simulation model provides repeatability of system behavior over time, thereby enabling criteria to evaluate game design against objectives and to allow comparison of results. For example, the serious game and evaluation apparatus can be configured with a system dynamics model that incorporates systems thinking and simulates underlying structures and dynamics of messy problems from the perspective of the complex system that creates them.

Embodiments of the innovation relate to a serious game and evaluation apparatus, comprising a controller having a memory and a processor. The controller is configured to display an interface of a serious game corresponding to a complex system, the serious game configured to provide a user with a learning experience applicable to a real-world scenario of the complex system; receive a first set of user behavior criteria from the user device, the first set of user behavior criteria related to critical thinking of the user prior to participation in the serious game by the user of the user device; receive a second set of user behavior criteria from the user device, the second set of user behavior criteria related to critical thinking of the user following participation in the serious game by the user; apply a rubric to the first set of user behavior criteria to generate a first rubric result and to the second set of user behavior criteria to generate a second rubric result, the rubric defining achievement criteria with respect to at least one dimension of systems thinking to evaluate critical thinking of the user; and generate an evaluation output relating to critical thinking of the user based upon a comparison of the first rubric result and the second rubric result.

Embodiments of the innovation relate to, in a serious game and evaluation apparatus, a method for assessing critical thinking of a user using a serious game, comprising: displaying, by the serious game and evaluation apparatus, an interface, such as a dashboard, of the serious game corresponding to a complex system, the serious game configured to provide a user with a learning experience relative to a real-world scenario of the complex system; receiving, by the serious game and evaluation apparatus, a first set of user behavior criteria from a user device, the first set of user behavior criteria related to critical thinking of the user prior to participation in the serious game by the user of the user device; receiving, by the serious game and evaluation apparatus, a second set of user behavior criteria from the user device, the second set of user behavior criteria related to critical thinking of the user following participation in the serious game by the user; applying, by the serious game and evaluation apparatus, a rubric to the first set of user behavior criteria to generate a first rubric result and to the second set of user behavior criteria to generate a second rubric result, the rubric defining achievement criteria with respect to at least one dimension of systems thinking to evaluate critical thinking of the user; and generating, by the serious game and evaluation apparatus, an evaluation output relating to critical thinking of the user based upon a comparison of the first rubric result and the second rubric result.

### BRIEF DESCRIPTION OF THE DRAWINGS

The foregoing and other objects, features and advantages will be apparent from the following description of particular embodiments of the innovation, as illustrated in the accompanying drawings in which like reference characters refer to the same parts throughout the different views. The drawings are not necessarily to scale, emphasis instead being placed upon illustrating the principles of various embodiments of the innovation.

FIG. 1 illustrates a schematic representation of a serious game and evaluation system, according to one arrangement.

FIG. 2 illustrates a flowchart of a method performed by a serious game and evaluation apparatus of the serious game and evaluation system of FIG. 1, according to one arrangement.

FIG. 3 illustrates a schematic representation of the serious game and evaluation apparatus of FIG. 1 executing a rubric management model, according to one arrangement

FIG. 4 illustrates an example rubric associated with a rubric management model of the serious game and evaluation apparatus of FIG. 1, according to one arrangement.

FIG. 5 illustrates a schematic representation of the serious game and evaluation apparatus of FIG. 1 having a systems dynamic model as the serious game, according to one arrangement.

FIG. 6 illustrates a schematic representation of the serious game and evaluation apparatus of FIG. 3 generating an interface of a system dynamics simulation, according to one arrangement.

### DETAILED DESCRIPTION

Embodiments of the present innovation relate to a method and apparatus for serious game execution and evaluation. In one arrangement, a serious game and evaluation apparatus is configured to execute a rubric management model for evaluation of perceived problems and changes to systems thinking of game participants of a serious game to inform learning objectives. Rubrics are evaluation tools that can be used to inform, measure, and evaluate learning objectives. Systems thinking, arguably an aspect of critical thinking, offers a foundation to understand a complex system as a whole entity, as opposed to understanding the smaller, individual parts that make up the whole. For example, when executing the rubric management model, the serious game and evaluation apparatus can measure changes to dimensions of systems thinking of game participants while exploring a complex system and messy problem of interest. As such, the serious game and evaluation apparatus provides a measurement tool to inform and evaluate learning objectives for serious gaming, such as learning for leaders or strategists in any industry or research field as well as military and national security needs.

In one arrangement, the serious game and evaluation apparatus is configured to generate, as the serious game, a dynamic simulation model which integrates both system dynamics modeling and wargaming to provide simulation of a complex system (e.g., where the complex system can include organized combinations of integrated social-technical-economic-biological phenomena) and messy problems. As such, the dynamic simulation model provides repeatability of system behavior over time, thereby enabling criteria to evaluate game design against objectives and to allow comparison of results. For example, the serious game and evaluation apparatus can be configured with a system dynamics model that incorporates systems thinking and simulates underlying structures and dynamics of messy problems from the perspective of the complex system that creates them.

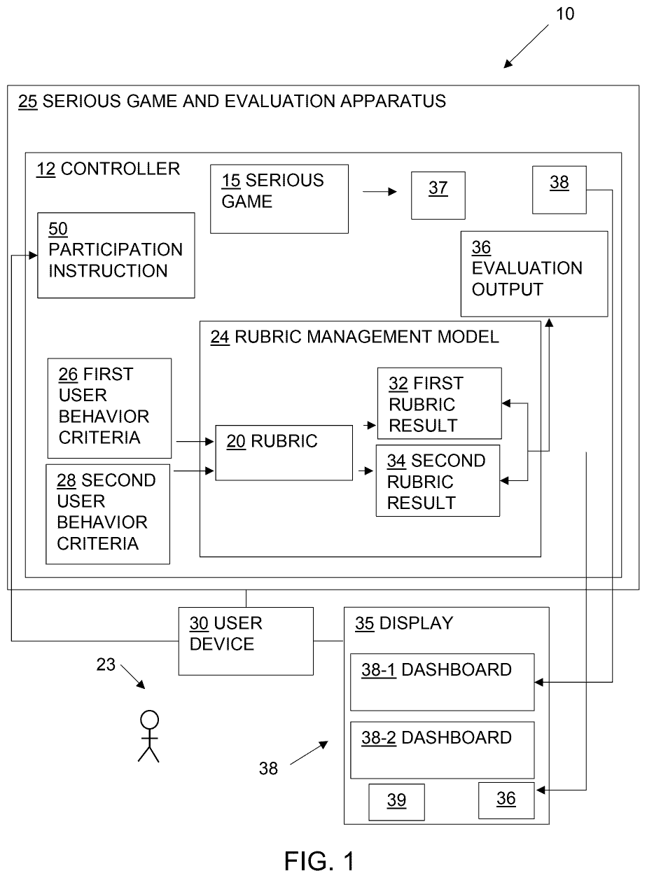

FIG. 1 illustrates a schematic representation of a serious game and evaluation system 10, according to one arrangement.

As shown, the serious game and evaluation system 10 includes a serious game and analysis system apparatus 25. The serious game and analysis system apparatus 25 can be a computerized device, such as a personal computer, laptop, or tablet, and can include a controller 12, such as a memory and a processor. As will be described in detail below, the serious game and analysis system apparatus 25 is configured to execute a serious game 15 and a rubric management model 24 to analyze systems thinking of game participants while exploring the complex system represented by the serious game. Further, the serious game and evaluation system 10 can include one or more user devices 30 disposed in electrical communication with serious game and analysis apparatus 25, such as via a network (e.g., 18, a wide-area network (WAN) or a local area network (LAN)). Each user device 30 can be configured as a computerized device, such as a personal computer, laptop, or tablet, and can include including a controller 31, such as a memory and a processor.

The serious game 15 executed by the serious game and analysis system apparatus 25 conceptualizes a messy problem by defining a complex system to create the messy problem and is configured to provide a user 23 with a learning experience relative to a real-world scenario of the complex system. In one arrangement, the controller 12 is configured to generate the serious game 15, such as a wargame. For example, in the case where the serious game 15 is configured as a wargame, such as the conventional wargame Battle for Moscow, the serious game 15 provides the user 23 with a war time scenario and the implementation of policy spaces such as the tactical use of forces to win a battle between two military forces as the complex system. The controller 12 can be configured to develop the serious game 15 in a variety of ways, such as by utilizing conventional agent-based modelling techniques, game development software, or non-computational mechanisms.

In one arrangement, the controller 12 is configured to execute a rubric management model 24 to evaluate systems thinking skills of a user 23 relative to the serious game 15 and to explore and manage complex system output from a messy problem space, such as embodied by the serious game 15. The rubric management model 24 can be developed by the serious game and evaluation apparatus 25 via machine learning or artificial intelligence such as large language models.

In one arrangement, the rubric management model 24 is configured to utilize a rubric 20 when evaluating systems thinking skills of the user 23. For example, the rubric 20 can be configured an assessment tool that identifies an explicit set of achievement criteria to assess systems thinking performance of the user 23 with respect to the serious game 15.

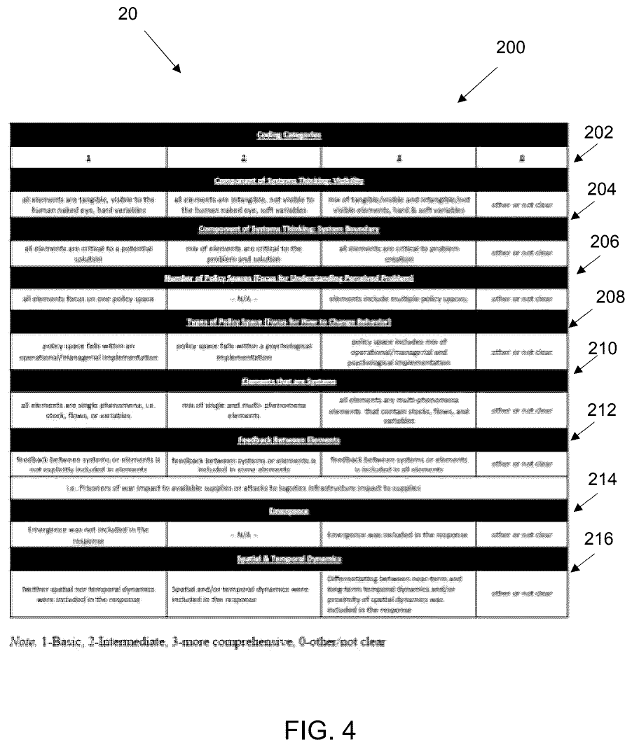

In one arrangement, the rubric 20 is configured as a scoring guide that defines the mechanisms for assessing and evaluating the quality of dimensions of the user's system thinking under scrutiny. For example, the rubric 20 can be configured as scoring mechanism associated with a set of questions 70, such as a user survey, to evaluate change to eight dimensions of a user's 23 systems thinking when using the serious game 15. The eight dimensions of systems thinking evaluated by the rubric 20 can include dimensions related to sensibility (e.g., visibility, systems as elements, feedback between elements), literacy (e.g., system boundary, number of policy spaces, emergence, spatial/temporal dynamics), and capability (e.g., types of policy spaces). FIG. 4 illustrates an example of the eight dimensions included within, and analyzed using, the rubric 20. In one arrangement, the rubric 20 can also include a ninth dimension to identify the user's perception of the problem provided or defined by the serious game 15.

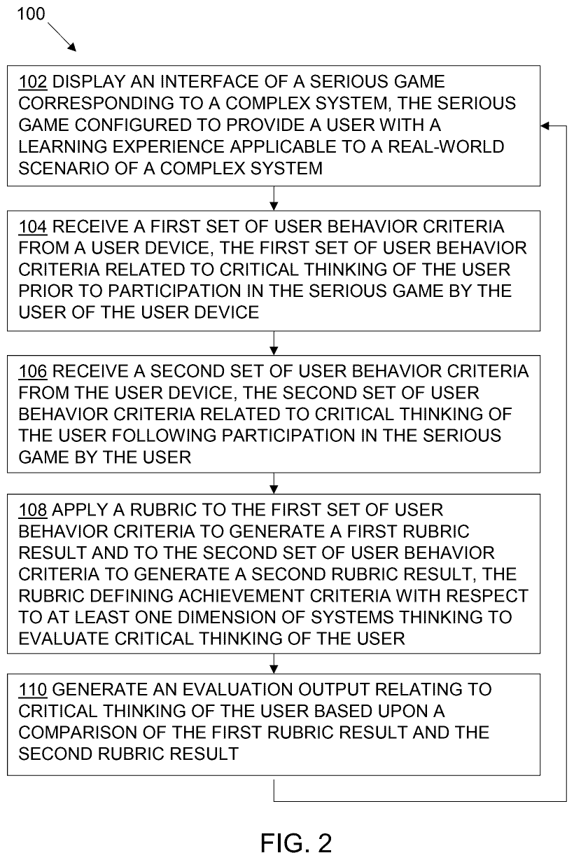

As provided above, the controller 12 utilizes the rubric management model 24 in combination with the serious game 15 as an intervention tool to evaluate the impact to systems thinking leadership on a user 23. FIG. 2 illustrates a flowchart 100 of a method performed by the controller 12 of the serious game and evaluation apparatus 25 when evaluating such an impact, according to one arrangement.

In element 102, the controller 12 is configured to display an interface 38, such as a dashboard, of a serious game 15 corresponding to a complex system, the serious game 15 configured to provide a user with a learning experience applicable to a real-world scenario of a complex system.

In one arrangement, with reference to FIG. 1, upon start, the serious game and evaluation apparatus 25 executes the serious game 15 to generate an interface 38, such as a first interface 38-1, which provides the user 23 with the ability to interact with the serious game and evaluation apparatus 25 and the serious game 15. For example, following generation of the interface 38, the serious game and evaluation apparatus 25 can transmit the interface 38 to the user device 30 for display on a display 35 disposed in electrical communication with the user device 30. As provided above, assume the case where the serious game 15 is configured as a wargame, such as the conventional wargame Battle for Moscow. As such, the serious game 15 can provide the user 23 with a war time scenario as the real-world complex system. Based upon the user's interaction with the serious game 15, the serious game and evaluation apparatus 25 is configured to measure user's learning experience based on an evaluation of changes to dimensions of systems thinking and/or an assessment of the user's critical thinking, as will be described below.

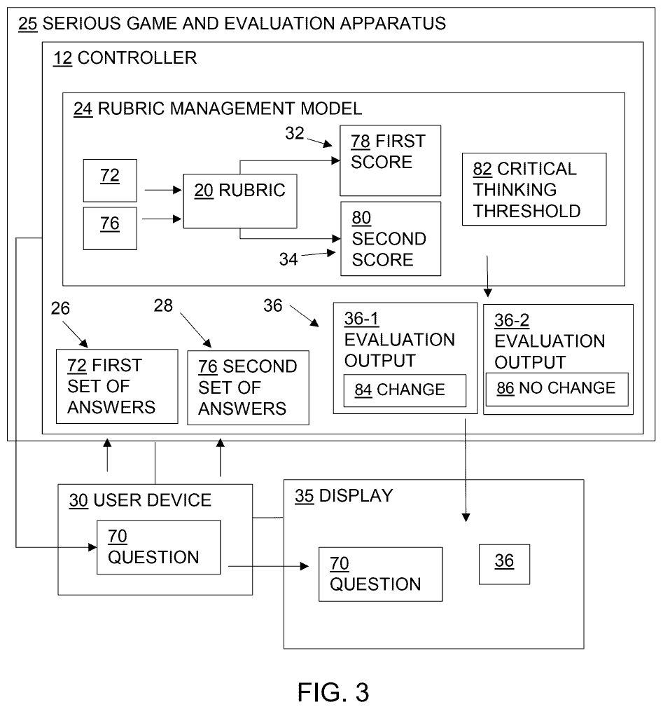

Returning to FIG. 2, in element 104, the controller 12 is configured to receive a first set of user behavior criteria 26 from a user device 30, the first set of user behavior criteria 32 related to critical thinking of a user 23 prior to participation in the serious game 15 by the user 23 of the user device 30. For example, with additional reference to FIG. 3, before the user 23 can interact with the serious game 15 via the interface 38-1, the rubric management model 24 provides a set of questions 70 to the user 23 such as via the user device 30 and display 35. The set of questions 70 relate to the real-world scenario of the complex system, such as the war time scenario modeled by the serious game 15. In response to receiving the set of questions 70, the user 23 generates a first set of answers 72, such as textual responses to the questions 70, and transmits the first set of answers 72 as the first set of user behavior criteria 26 to the serious game and evaluation apparatus 25 via the user device 30.

In one arrangement, with reference to FIG. 1, following receipt of the first set of user behavior criteria 26 from the user device 30, the serious game and evaluation apparatus 25 is configured to allow the user 23 to participate in the serious game 15. For example, the serious game and evaluation apparatus 25 can provide an activation controller 39 as part of the first interface 38-1. In response to selection of the activation controller 39 by the user 23, the user device 30 is configured to transmit a participation instruction 50 to the serious game and evaluation apparatus 25.

In response to reception of the participation instruction 50, the serious game and evaluation apparatus 25 is configured to execute the serious game 15 to generate a serious game output 37. In one arrangement, the serious game 15 can include a variety of preset parameters which, when the apparatus 25 executes the serious game 15, can be applied to the serious game 15 to change or adjust the real-world scenario of the complex system, as modeled by the serious game 15.

For example, in the case where the serious game 15 is configured as a war game, one preset parameter can include a preset change of an invading force commander at a given point which results in combat odds to attack being reduced to zero (always attack) and no prisoners of war being taken. Further, a set of preset parameters can identify an output behavior of the resistance force as having high morale, the state of resilience being strong and growing, and the state of the invasion being weak but connected. Additionally, a set of preset parameters can identify an output behavior of the morale of the invasion force as being low, and the size of invasion force being about ⅓ of the resistance force. As such, when the serious game and evaluation apparatus 25 executes the serious game 15, the serious game and evaluation apparatus 25 can apply one or more of these parameters to the serious game 15 to generate the serious game output 37 having an adjusted real-world scenario of the complex system modeled by the serious game 15.

During execution of the serious game 15, assume the case where following receipt of the participation instruction 50, serious game and evaluation apparatus 25 applies a preset parameter to the serious game 15 identifying a change to the invading force commander. Further assume that such application results in the serious game 15 generating a serious game output 37 identifying the invading force as not achieving its victory condition of controlling 75% of the territory of the resistance force. As such, application of the preset parameter to the serious game 15 results in a change to the real-world scenario of the complex system modeled by the serious game 15.

In one arrangement, prior to selection of the activation controller 39, the user 23 can adjust one or more parameters associated with the serious game 15 and can transmit the parameter adjustment criteria to the serious game and evaluation apparatus 25 with the participation instruction 50. For example, the user 23 can adjust weather parameters or attack/defense parameters associated with the wargame scenario of the serious game 15 as the parameter adjustment criteria. Following selection of the activation controller 39, the user device 30 transmits the participation instruction 50 and the parameter adjustment criteria to the serious game and evaluation apparatus. Accordingly, following receipt of the instruction 50, the apparatus 25 can apply the parameter adjustment criteria to the serious game 15 prior to execution to generate a serious game output 37 having an adjusted real-world scenario of the complex system based upon the user parameter adjustment input.

Following generation of the serious game output 37, the serious game and evaluation apparatus 25 is configured to output a corresponding, subsequent interface 38-2 of the serious game 15 which identifies a change to a relevant real-world scenario of the complex system. For example, the subsequent interface 38-2 can transmit the subsequent interface 38-2 to the user device 30 for display to the user 23 by the display 35. The subsequent interface 38-2 can identify the change in the real-world (e.g., wargame) scenario of the invading force not achieving its victory condition of controlling 75% of the territory of the resistance force.

Returning to FIG. 2, in element 106, the controller 12 is configured to receive a second set of user behavior criteria 28 from the user device 30, the second set of user behavior criteria 28 related to critical thinking of the user 23 (e.g., the ability of the user 23 to analyze the serious game 15 and to make reasonable choices or conclusions based upon the analysis) following participation in the serious game 15 by the user 23. In one arrangement, the second set of user behavior criteria 28 identifies the user's mindset or critical thinking following review of the serious game output 37 presented by the subsequent interface 38-2 following execution of the serious game 15 by the serious game and evaluation apparatus 25.

For example, with reference to FIG. 3 following transmission of the subsequent interface 38-2 to the user device 30, the rubric management model 24 provides the set of questions 70 to the user 23, such as via the user device 30 and display 35. As provided above, the set of questions 70 relate to the real-world scenario of the complex system, such as the war time scenario modeled by the serious game 15. In response to receiving the set of questions 70, the user 23 generates a second set of answers 76, such as textual responses and transmits the second set of answers 76 as the second set of user behavior criteria 28 to the serious game and evaluation apparatus 25 via the user device 30.

Returning to FIG. 2, in element 108, the controller 12 is configured to apply a rubric 20 to the first set of user behavior criteria 26 to generate a first rubric result 32 and to the second set of user behavior criteria 28 to generate a second rubric result 34, the rubric 20 defining achievement criteria with respect to at least one dimension of systems thinking to evaluate critical thinking of the user 23. For example, the dimensions of systems thinking can include dimensions related to sensibility, literacy, capability, learning components of systems thinking, and the user's perception of the problem provided or defined by the serious game 15, such as illustrated in FIG. 4.

In one arrangement, the rubric management model 24 is configured to utilize the rubric 20 to generate first and second scores 78, 80 as the first and second rubric results 32, 34. For example, with reference to FIG. 3, the rubric management model 24 can be a large language model configured to identify the content and context of the textual responses of the first and second sets of answers 72, 76. Following such identification of the textual responses of the first and second sets of answers 72, 76, the rubric management model 24 is configured to apply the rubric 20 to the content and context of the first and second sets of user behavior criteria 26, 28 to identify changes to the systems thinking of the user 23.

For example, the rubric management model 24 is configured to apply the rubric 20 to the first set of answers 72 to generate a first score 78. For example, with reference to FIG. 4, the rubric 20 can be configured as a scoring guide 200. The rubric management model 24 can apply the rubric 20 to the first set of answers 72 to assign each answer of the first set of answers 72 as relating to one of the dimensions identified by the scoring guide 202-216. Further, once assigned by dimensionality, the rubric management model 24 is configured to apply the rubric 20 to each answer of the first set of answers 72 to generate a score associated with each answer. For example, following assignment of each answer of the first set of answers 72 into one of the scoring guide dimensions 202-216, the rubric management model 24 can classify each answer into one of four categories (e.g., basic, intermediate, more comprehensive, or not clear), and can assign each answer a score based upon the evaluation and coding (e.g., 1, 2, 3, or zero). In one arrangement, following application of the rubric 20 to the first set of answers 72, the rubric management model 24 is configured to generate the scores associated with the first set of answers 72 to generate the first score 78.

Next, as shown in FIG. 3, the rubric management model 24 is configured to apply the rubric 20 to the second set of answers 76 to generate a second score 80. For example, the rubric management model 24 can apply the rubric 20 to the second set of answers 76 to assign each answer of the first set of answers 72 as relating to one of the dimensions identified by the scoring guide 202-216. Further, once assigned by dimensionality, the rubric management model 24 is configured to apply the rubric 20 to each answer of the second set of answers 76 to generate a score associated with each answer. In one arrangement, following application of the rubric 20 to the second set of answers 76, the rubric management model 24 is configured to generate the scores associated with the second set of answers 76 to generate the second score 80.

In one arrangement, the rubric management model 24 can receive the first and second scores 78, 80 from an external source. For example, a human can evaluate the user behavior criteria 26, 28 using the rubric 20. For example, the human can utilize the rubric 20 to classify and score each answer of the first and second sets of answers 72, 76. The human can then forward the resulting first and second scores 78, 80 to the rubric management model 24 for further processing.

Returning to FIG. 2, in element 110, the controller 12 is configured to generate an evaluation output 36 relating to critical thinking of the user based upon a comparison of the first rubric result 32 and the second rubric result 34. For example, the evaluation output 36 can indicate whether or not the user 23 has correctly identified the global problem or a regional problem or problems associated with solutions of the serious game 15 and can indicate if the critical thinking of the user 23 has changed from pre-participation to post-participation in the serious game 15. The evaluation output 36 can also provide the user 23 with guidance with respect to the serious game 15 to help adjust the user's systems thinking.

In one arrangement, with reference to FIG. 3, when comparing the first and second rubric results 32, 34 the rubric management model 24 is configured to utilize a critical thinking threshold 82. For example, the critical thinking threshold 82 can be configured as a threshold score identifying a change to critical thinking of the user, such as a score of 1.0. Assume the case where the first score 78 is 2 and the second core 80 is 3. When evaluating the first score 78 and the second score 80 relative to the critical thinking threshold 82, the rubric management model 24 can identify an increase between the scores 78, 80 of 1.0, which corresponds to the 1.0 value of the critical thinking threshold 82. In such a case, the rubric management model 24 can generate an evaluation output 36-1 identifying a change 84 to critical thinking of the user. However, assume the case where the first score 78 is 3 and the second core 80 is 2. When evaluating the first score 78 and the second score 80 relative to the critical thinking threshold 82, the rubric management model 24 can identify a decrease between the scores 78, 80 of −1. In such a case, the rubric management model 24 can generate an evaluation output 36-2 identifying a different type of change 84 to critical thinking of the user.

In one arrangement, the serious game and evaluation apparatus 25 can forward the evaluation output 36 to the user device 30 for display by the display 36. Based upon the evaluation output 36, the user 23 can repeat the process of participating in the serious game 15 such that the controller 12 returns to element 102 and the user 23 provides additional sets of second user behavior criteria 28 (e.g., answers to questions 70 received following subsequent executions of the serious game 15) to the serious game and evaluation apparatus 25. Based upon subsequent evaluation outputs 36, the user 23 can adjust his decisions in the serious game 15.

As provided above, with use of the rubric management model 24 in combination with the serious game 15, the serious game and evaluation apparatus 25 is configured as an intervention tool to evaluate the impact to systems thinking leadership on a user 23. For example, when executing the rubric management model 24, the serious game and evaluation apparatus 25 can measure changes to dimensions of systems thinking of game participants 23 while exploring a complex system and messy problem of interest. As such, the serious game and evaluation apparatus 25 provides a measurement tool to inform and evaluate learning objectives for serious gaming, such as learning for leaders or strategists in any industry or research field as well as military and national security needs.

As provided above, conventional wargames explore messy problems, use qualitative techniques, and support decision-making that considers political, social, and technical relationships. In addition to these elements, system dynamics models also incorporate quantitative techniques to simulate over-time behavior characteristics of interwoven systems that create messy problems. As such, contrary to conventional wargames, system dynamics models provide the ability to conceptualize a messy problem by defining a complex system to create the messy problem. with repeatable objective and quantitative measures.

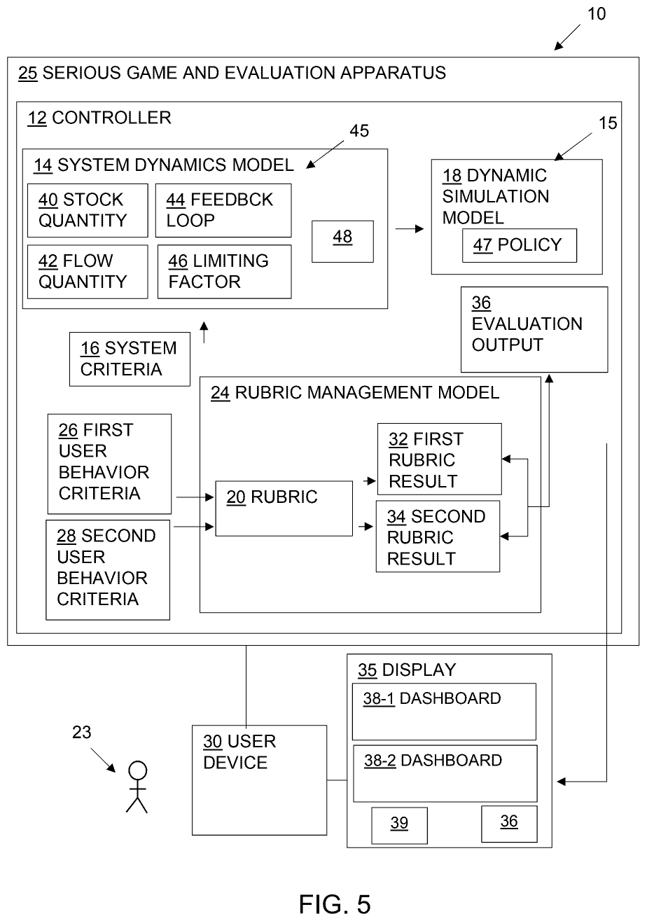

In one arrangement, with reference to FIG. 5, in order to generate repeatable behaviors of complex systems and provide an understanding of the underlying structures and behaviors of messy problems, the serious game and analysis system apparatus 25 is configured to utilize a system dynamics model 14 to develop a dynamic simulation model 18 as the serious game 15.

The systems dynamic model 14 represents a real-world scenario of the complex system being modeled, such as representations of real-world phenomena represented by mathematical and computations. For example, the system dynamics model 14 simulates quantitative models of complex systems using repeating structures of behavior, typically referred to as molecules 45 of the system dynamics model 14. As such, the molecules 45 simulate the underlying interconnected structure of a system consisting of tangible and intangible phenomena responsible for dynamic behaviors of interest. Further, the molecules 45 can represent mathematical calculations of computational coding to simulate repeatable dynamic behaviors.

For example, the systems dynamic model 14 can include, as molecules 45, stock quantities 40 which represent tangible or intangible phenomena such as within the complex system, flow quantities 42 which represent accumulations and/or rates of change relative to the tangible or intangible phenomena within the complex system, and feedback loop processes 44 which represent relationships between phenomena and simulate linear and non-linear, oscillating, goal-seeking, decay, and other steady-state behaviors. The system dynamics model 14 can also include, as a molecule 45, a limiting factor 46, such as delays or constraints or the availability of assets within the complex system. Together these molecules 45 represent the real-world scenario of the complex system and simulate the underlying interconnected structure of a real-world complex system responsible for messy behaviors of interest. The system dynamics model 14 can also include molecules 45, such as contextual factors 48, that represent scenario-based background information to provide the game participant with situational context.

During development of the dynamic simulation model 18, the controller 12 is configured to apply system criteria 16, such as complex systems and systems thinking, to the system dynamics model 14 to generate the dynamic simulation model 18 as the serious game 15. In one arrangement, the controller 12 can be configured with a generic system dynamics model 14 and can receive system criteria 16 from an external source, such as from a serious game designer, which define a particular complex system. The system criteria 16 can include definitions of various molecules 45 of the system dynamics model 14, as well as the interactions of those molecules 45.

For example, the system criteria 16 can define population information pertaining to a real-world system being modeled. The controller 12 is configured to incorporate this population information as a stock quantity 40 of the systems dynamic model 14. The system criteria 16 can also define birth and death rate information pertaining to a real-world system being modeled.

The controller 12 is configured to incorporate this birth and death rate information as a flow quantity 42 of the systems dynamic model 14. In one arrangement, the controller 12 can link the stock quantity 40 and the flow quantity 42 together as a feedback loop processes 44, since, based upon the birth rate and death rate of the real-world system, the modeled population can change over time. Additionally, the system criteria 16 can define the availability of land within the real-world system or the availability of tax revenue within the real-world system. The controller 12 is configured to incorporate this information as a limiting factor 46 of the systems dynamic model 14. In one arrangement, the controller 12 is configured to combine various molecules 45 to simulate more complex behaviors of the real-world system. The resulting dynamic simulation model 18 is configured to educate users 23 using underlying structural dynamics of real-world problems to familiarize the users 23 with messy problem structures and how to manage them for long-term and short-term success.

In one arrangement, the serious and evaluation apparatus 25 is configured to generate the dynamic simulation model 18 having repeating structures of behavior. For example, assume the case where the dynamic simulation model 18 models a wartime resistance problem. In such a case, the dynamic simulation model 18 can include mathematical ordering functions for deploying troops; co-flows for troop combat experience and morale; third order material delays for logistics infrastructure, communications infrastructure, and supplies; and third order information delays for information. The serious and evaluation apparatus 25 is configured to generate seeded noise distribution calculations with respect to these elements to allow repeatability of uncertainty across multiple simulation runs. As such, consistency of dimensions throughout the dynamic simulation model 18 enables equitable comparison of policy choice outcomes within uncertain operational and environmental conditions.

In one arrangement, the system dynamics model 14 can define policy space parameters 47 as part of the dynamic simulation model 18 and as associated with the real-world system being modeled. The policy space parameters 47 for the dynamic simulation model 18 refers to variables and behavioral phenomena that contribute to a stakeholder perspective, creating or modifying the problem of interest, as opposed to formal or legal doctrine or regulations. Formal or legal doctrine or regulations can exist, however, for the purpose of exploring a messy problem to understand its leverage points and behavioral changes. However, policy space parameters 47, relate to categorical areas, such as legal doctrine or regulations, that the user 23 can manipulate to change system behavior.

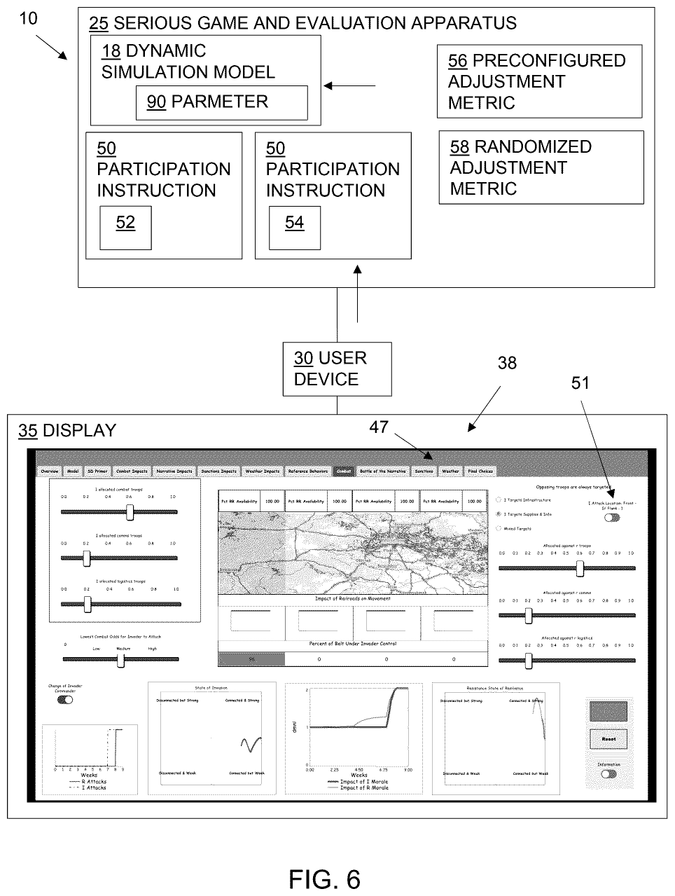

For example, with additional reference to FIG. 6, in the case where the dynamic simulation model 18 models a wartime resistance problem, the system dynamics model 14 can generate the system dynamics model 18 which include policy space parameters 47 such as sanctions and public sentiment. During operation, as will be discussed below, when participating with the dynamic simulation model 18, the user 23 can select particular policy space parameters 47 and adjust system parameters within the policy space to change the behavior of the dynamic simulation model 18.

During operation, and with reference to FIGS. 5 and 6. upon start, the serious game and evaluation apparatus 25 executes the dynamic simulation model 18 to generate an interface 38 having policy space parameters 47, such as a first interface 38-1. Following receipt of first user behavior criteria 26, the serious game and evaluation apparatus 25 which provides the user 23 with the ability to interact with the serious game and evaluation apparatus 25 and the dynamic simulation model 18.

In one arrangement, the dynamic simulation model 18 is configured to allow a game participant or end user 23 to adjust one or more parameters 90 associated with the dynamic simulation model 18. For example, the user 23 can select a weather policy space parameter 47 to display an interface associated with the weather of dynamic simulation model 18. The user 23 can adjust weather parameters associated with the wartime resistance problem modeled by the dynamic simulation model 18, either as a user-selected adjustment metric 52, where the user defines the change to the weather (e.g., rainy for two weeks) or as a user-selected randomization instruction 54 where the user 23 instructs the serious game and evaluation apparatus 25 to randomly define the changes to weather (e.g., rainy for one week). The user device 30 can include either of these selections 52, 54 as part of the participation instruction 50 transmitted to the serious game and evaluation apparatus 25.

Following receipt of either the user-selected adjustment metric 52 or the user-selected randomization instruction 54, the serious game and evaluation apparatus 25 is configured to adjust a system parameter 90 of the dynamic simulation model 18 based upon the selection 52, 54 and execute the dynamic simulation model 18 with the adjusted parameter 90. Following execution of the dynamic simulation model 18, the serious game and evaluation apparatus 25 is configured to generate a serious game output 37 as well as a subsequent interface 38-2 for transmission to the user device 30 and for display by the display 35. The serious game and evaluation apparatus 25 is then configured to execute the rubric management model 24 as described above.

Following receipt of the participation instruction 50, the dynamic simulation model 18 can be configured to allow the serious game and evaluation apparatus 25 to adjust one or more parameters 90 associated with the dynamic simulation model 18. In one arrangement, the serious game and evaluation apparatus 25 can include a preconfigured adjustment metric 56 which defines a preset change to the parameter 90 of the dynamic simulation model 18. For example, preconfigured adjustment metric 56 can include a preset change of an invading force commander at a given point which results in combat odds to attack being reduced to zero (e.g., always attack) and no prisoners of war being taken. In another example, the serious game and evaluation apparatus 25 can include a randomized adjustment metric 58 which configures the serious game and evaluation apparatus 25 to randomly define a change to parameters 90 associated with the dynamic simulation model 18.

Following receipt of either the preconfigured adjustment metric 56 or the randomized adjustment metric 58, in addition to the participation instruction 50, the serious game and evaluation apparatus 25 is configured to adjust a system parameter 90 of the dynamic simulation model 18 based upon the metrics 56, 58 and execute the dynamic simulation model 18 with the adjusted parameter 90. Following execution of the dynamic simulation model 18, the serious game and evaluation apparatus 25 is configured to generate a serious game output 37 as well as a subsequent interface 38-2 for transmission to the user device 30 and for display by the display 35. The serious game and evaluation apparatus 25 is then configured to execute the rubric management model 24 as described above.

The dynamic simulation model 18 configured using the system dynamics model 14 provides repeatability of situational conditions and behavioral responses of an underlying complex system that creates resistance behavior, thereby addressing a technical problem of conventional wargames. Consistency of problem response behavior is enabled with dimensional consistency (e.g. of phenomena and equations) throughout the dynamic simulation model 18.

Wargaming and system dynamics modeling, when performed separately, are conventional approaches used to understand complex systems and messy problems in national security and other industries. By contrast, embodiments of the serious game and evaluation system 10 are configured to create and measure explicit quantifiable and objective learning objectives for game participants and is repeatable. Further, embodiments of the serious game and evaluation system 10 utilize a systems thinking rubric to evaluate change to critical thinking of a user or participant 23.

Many organizations spend large amounts of resources to conduct wargames or other serious games to educate their leaders and workforce but these games cannot be repeated nor do they objectively measure learning of participants. With the conventional state of wargaming technology, these wargames are single-use and are regarded as “one-offs.” By contrast, the serious game and evaluation system 10 allows repeatability and reuse of a dynamic simulation model 18 developed using system dynamics modeling 14 and informs learning objectives and evaluates the change to critical thinking (such as systems thinking of users or game participants 23) to develop systems thinking leaders and strategists.

While various embodiments of the innovation have been particularly shown and described, it will be understood by those skilled in the art that various changes in form and details may be made therein without departing from the spirit and scope of the innovation as defined by the appended claims.

What is claimed is:

1. A serious game and evaluation apparatus, comprising:
a controller having a memory and a processor, the controller configured to:
display an interface of a serious game corresponding to a complex system, the serious game configured to provide a user with a learning experience applicable to a real-world scenario of a complex system;
receive a first set of user behavior criteria from a user device, the first set of user behavior criteria related to critical thinking of the user prior to participation in the serious game by the user of the user device;
receive a second set of user behavior criteria from the user device, the second set of user behavior criteria related to critical thinking of the user following participation in the serious game by the user;
apply a rubric to the first set of user behavior criteria to generate a first rubric result and to the second set of user behavior criteria to generate a second rubric result, the rubric defining achievement criteria with respect to at least one dimension of systems thinking to evaluate critical thinking of the user; and
generate an evaluation output relating to critical thinking of the user based upon a comparison of the first rubric result and the second rubric result.

2. The serious game and evaluation apparatus of claim 1, wherein the controller is configured to:
following receipt of the first set of user behavior criteria from the user device, receive a participation instruction from the user device; and
output a subsequent interface of the serious game, the subsequent interface identifying a change to a relevant real-world scenario of the complex system.

3. The serious game and evaluation apparatus of claim 1, wherein:
when receiving the first set of user behavior criteria from the user device, the controller is configured to:
provide a set of questions to the user, the set of questions related to the real-world scenario of the complex system, and
receive a first set of answers to the set of questions as the first set of user behavior criteria from the user device; and
when receiving a second set of user behavior criteria from the user device, the controller is configured to:
provide the set of questions to the user, the set of questions related to the real-world scenario of the complex system, and
receive a second set of answers to the set of questions as the second set of user behavior criteria from the user device.

4. The serious game and evaluation apparatus of claim 3, wherein when applying the rubric to the first set of user behavior criteria to generate a first rubric result and to the second set of user behavior criteria to generate a second rubric result, the controller is configured to:
apply the rubric to the first set of answers to generate a first score; and
apply the rubric to the second set of answers to generate a second score.

5. The serious game and evaluation apparatus of claim 3, wherein when generating the evaluation output relating to critical thinking of the user based upon the comparison of the first rubric result and the second rubric result, the controller is configured to:
evaluate the first score and the second score relative to a critical thinking threshold;
when the evaluation corresponds to the critical thinking threshold, generate an evaluation output identifying a change to critical thinking of the user; and
when the evaluation lacks a correspondence to the critical thinking threshold, generate an evaluation output identifying an absence of change to critical thinking of the user.

6. The serious game and evaluation apparatus of claim 1, wherein the controller is configured to apply system criteria to a system dynamics model to generate a dynamic simulation model of the complex system as the serious game.

7. The serious game and evaluation apparatus of claim 6, wherein the dynamic simulation model comprises at least one of a stock quantity, a flow quantity, a feedback loop process, and a limiting factor to represent the real-world scenario of the complex system.

8. The serious game and evaluation apparatus of claim 6, wherein the controller is configured to:
following receipt of a participation instruction, adjust a system parameter of the dynamic simulation model of the complex system based upon a preconfigured adjustment metric;
execute the dynamic simulation model having the adjusted system parameter; and
display the subsequent interface of the system dynamics simulation, the subsequent interface identifying the change to the real-world scenario of the complex system based upon the preconfigured adjustment metric.

9. The serious game and evaluation apparatus of claim 6, wherein the controller is configured to:
following receipt of a participation instruction, adjust a system parameter of the dynamic simulation model based upon a randomized adjustment metric;
execute the dynamic simulation model having the adjusted system parameter; and
display the subsequent interface of the system dynamics simulation, the subsequent interface identifying the change to the real-world scenario of the complex system based upon the randomized adjustment metric.

10. The serious game and evaluation apparatus of claim 6, wherein the controller is configured to:
when receiving a participation instruction from the user, receive a user-selected adjustment metric;
adjust a system parameter of the dynamic simulation model based upon the user-selected adjustment metric;
execute the dynamic simulation model having the adjusted system parameter; and
display the subsequent interface of the system dynamics simulation, the subsequent interface identifying the change to the real-world scenario of the complex system based upon the user-selected adjustment metric.

11. The serious game and evaluation apparatus of claim 6, wherein the controller is configured to:
when receiving a participation instruction from the user, receive a user-selected randomization instruction;
adjust a system parameter of the dynamic simulation model based upon the user-selected randomization instruction;
execute the dynamic simulation model having the adjusted system parameter; and
display the subsequent interface of the serious game, the subsequent interface identifying the change to the real-world scenario of the complex system based upon the user-selected randomization instruction.

12. The serious game and evaluation apparatus of claim 6, wherein the controller is configured to:
when receiving a participation instruction from the user, receive a user-selected policy space parameter;
receive one of a user-selected randomization instruction and a user-selected adjustment metric;
adjust a system parameter of the dynamic simulation model based upon the one of the user-selected randomization instruction and the user-selected adjustment metric;
execute the dynamic simulation model having the one of the user-selected randomization instruction and the user-selected adjustment metric; and
display the subsequent interface of the serious game, the subsequent interface identifying the change to the real-world scenario of the complex system based upon the one of the user-selected randomization instruction and the user-selected adjustment metric.

13. In a serious game and evaluation apparatus, a method for assessing critical thinking of a user using a serious game, comprising:
displaying, by the serious game and evaluation apparatus, an interface of the serious game corresponding to a complex system, the serious game configured to provide a user with a learning experience applicable to a real-world scenario of the complex system;
receiving, by the serious game and evaluation apparatus, a first set of user behavior criteria from a user device, the first set of user behavior criteria related to critical thinking of the user prior to participation in the serious game by the user of the user device;
receiving, by the serious game and evaluation apparatus, a second set of user behavior criteria from the user device, the second set of user behavior criteria related to critical thinking of the user following participation in the serious game by the user;
applying, by the serious game and evaluation apparatus, a rubric to the first set of user behavior criteria to generate a first rubric result and to the second set of user behavior criteria to generate a second rubric result, the rubric defining achievement criteria with respect to at least one dimension of systems thinking to evaluate critical thinking of the user; and
generating, by the serious game and evaluation apparatus, an evaluation output relating to critical thinking of the user based upon a comparison of the first rubric result and the second rubric result.

14. The method of claim 13, comprising:
following receipt of the first set of user behavior criteria from the user device, receiving, by the serious game and evaluation apparatus, a participation instruction from the user device; and
outputting, by the serious game and evaluation apparatus, a subsequent interface of the serious game, the subsequent interface identifying a change to a relevant real-world scenario of the complex system.

15. The method of claim 13, comprising:
when receiving the first set of user behavior criteria from the user device:
providing, by the serious game and evaluation apparatus, a set of questions to the user, the set of questions related to the real-world scenario of the complex system, and
receiving, by the serious game and evaluation apparatus, a first set of answers to the set of questions as the first set of user behavior criteria from the user device; and
when receiving a second set of user behavior criteria from the user device:
providing, by the serious game and evaluation apparatus, the set of questions to the user, the set of questions related to the real-world scenario of the complex system, and
receiving, by the serious game and evaluation apparatus, a second set of answers to the set of questions as the second set of user behavior criteria from the user device.

16. The method of claim 15, wherein applying the rubric to the first set of user behavior criteria to generate a first rubric result and to the second set of user behavior criteria to generate a second rubric result comprises:
applying, by the serious game and evaluation apparatus, the rubric to the first set of answers to generate a first score; and
applying, by the serious game and evaluation apparatus, the rubric to the second set of answers to generate a second score.

17. The method of claim 15, wherein generating the evaluation output relating to critical thinking of the user based upon the comparison of the first rubric result and the second rubric result comprises:
evaluating, by the serious game and evaluation apparatus, the first score and the second score relative to a critical thinking threshold;
when the evaluation corresponds to the critical thinking threshold, generating, by the serious game and evaluation apparatus, an evaluation output identifying a change to critical thinking of the user; and
when the evaluation lacks a correspondence to the critical thinking threshold, generating, by the serious game and evaluation apparatus, an evaluation output identifying an absence of change to critical thinking of the user.

18. The method of claim 13, further comprising applying, by the serious game and evaluation apparatus, system criteria to a system dynamics model to generate a dynamic simulation model as the serious game.

19. The method of claim 18, wherein the system dynamics model comprises at least one of a stock quantity, a flow quantity, a feedback loop process, and a limiting factor to represent the real-world scenario of the complex system.

20. The method of claim 18, comprising:
following receipt of a participation instruction, adjusting, by the serious game and evaluation apparatus, a system parameter of the system dynamics simulation based upon a preconfigured adjustment metric;
executing, by the serious game and evaluation apparatus, the dynamic simulation model having the adjusted system parameter; and
displaying, by the serious game and evaluation apparatus, the subsequent interface of the system dynamics simulation, the subsequent interface identifying the change to the real-world scenario of the complex system based upon the preconfigured adjustment metric.

21. The method of claim 18, comprising:
following receipt of a participation instruction, adjusting, by the serious game and evaluation apparatus, a system parameter of the system dynamics simulation based upon a randomized adjustment metric;
executing, by the serious game and evaluation apparatus, the system dynamics simulation having the adjusted system parameter; and
displaying, by the serious game and evaluation apparatus, the subsequent interface of the system dynamics simulation, the subsequent interface identifying the change to the real-world scenario of the complex system based upon the randomized adjustment metric.

22. The method of claim 18, comprising:
when receiving a participation instruction from the user, receiving, by the serious game and evaluation apparatus, a user-selected adjustment metric;
adjusting, by the serious game and evaluation apparatus, a system parameter of the dynamic simulation model based upon the user-selected adjustment metric;
executing, by the serious game and evaluation apparatus, the dynamic simulation model having the adjusted system parameter; and
displaying, by the serious game and evaluation apparatus, the subsequent interface of the system dynamics simulation, the subsequent interface identifying the change to the real-world scenario of the complex system based upon the user-selected adjustment metric.

23. The method of claim 18, comprising:
when receiving a participation instruction from the user, receiving, by the serious game and evaluation apparatus, a user-selected randomization instruction;
adjusting, by the serious game and evaluation apparatus, a system parameter of the dynamic simulation model based upon the user-selected randomization instruction;
executing, by the serious game and evaluation apparatus, the dynamic simulation model having the adjusted system parameter; and
displaying, by the serious game and evaluation apparatus, the subsequent interface of the serious game, the subsequent interface identifying the change to the real-world scenario of the complex system based upon the user-selected randomization instruction.

24. The method of claim 18, comprising:
when receiving a participation instruction from the user, receiving, by the serious game and evaluation apparatus, a user-selected policy space parameter;
receiving, by the serious game and evaluation apparatus, one of a user-selected randomization instruction and a user-selected adjustment metric;
adjusting, by the serious game and evaluation apparatus, a system parameter of the dynamic simulation model based upon the one of the user-selected randomization instruction and the user-selected adjustment metric;
executing, by the serious game and evaluation apparatus, the dynamic simulation model having the one of the user-selected randomization instruction and the user-selected adjustment metric; and
displaying, by the serious game and evaluation apparatus, the subsequent interface of the serious game, the subsequent interface identifying the change to the real-world scenario of the complex system based upon the one of the user-selected randomization instruction and the user-selected adjustment metric.
